(19) United States
(12) Patent Application Publication
(10) Pub. No.: US 2015/0293511 A1
(43) Pub. Date: Oct. 15, 2015

(54) APPLIANCES CONTROL DEVICES AND METHODS

(71) Applicant: Assaf LAUFER, Tel-Aviv (IL)

(72) Inventor: Assaf Laufer, Tel Aviv (IL)

(21) Appl. No.: 14/438,899

(22) PCT Filed: Oct. 28, 2013
(86) PCT No.: PCT/IL2013/050881

§ 371 Date: Apr. 28, 2015

Related U.S. Application Data
(60) Provisional application No. 61/719,608, filed on Oct. 29, 2012.
(60) Provisional application No. 61/719,615, filed on Oct. 29, 2012.

(51) Int. Cl. G05B 15/02; H04L 12/28

(52) U.S. Cl. CPC G05B 15/02; H04L 12/2816

(57) ABSTRACT

A device for providing a unified control over common home appliances. The device comprises a distal control unit, a network communication unit receiving at least one of a plurality of control messages from said distal control unit, a signal receiving unit receiving an input operating signal from a proximal control unit for controlling a common home appliance, a signal transmitting unit transmitting an output operating signal controlling a common home appliance, and a managing module receiving data from said signal receiving unit and said network communication unit and choosing said output operating signal transmitted by said signal transmitting unit.

### FIELD AND BACKGROUND OF THE INVENTION

The present invention, in some embodiments thereof, relates to a remote monitoring of appliances and, more particularly, but not exclusively, to devices and methods for controlling appliances by receiving input operating signal(s) from a proximal control unit and receiving control message(s) from distal control unit, as well as transmitting output operating signal(s) to an appliance.

Several technologies for remotely controlling and monitoring electronic appliances positioned have been developed. These technologies include remotely controlling the power supply of electronic appliances by a telephone network, by a local area network (LAN) and/or by an internet enabled smart phone, which enables the smart phone connected to an infrared transmitter. Power supply to an electronic appliance can be remotely controlled, for example, by ring signals which reach a computer through a modem connected to a telephone network. The ring signals are sensed by the modem's ring sensor. Power supply to an electronic appliance can be remotely controlled when the electronic appliance is connected via an Ethernet connection, wherein power to the electronic appliance can be controlled remotely by providing a Magic Packet having a specific bit-stream to the electronic appliance to be controlled from the user's terminal. Any user's terminal which can access the Internet may be used for this control method. However, a separate LAN is needed when a remote control system is employed at home, and thus, there is an extra expense to construct the system. Power supply to an electronic appliance can be remotely controlled by a software application installable on an internet enabled smart phone, such as third generation (3G), fourth generation (4G) or wireless, which enables the smart phone to connect to an infrared transmitter via a secure wireless network connection. The software application is configured to control an appliance and translates user input into distinct device commands for an infrared transmitter to transmit to the appropriate device.

### SUMMARY OF THE INVENTION

According to some embodiments of the present invention, there is provided a device for providing a unified control over common home appliances. The device comprises a distal control unit, a network communication unit receiving at least one of a plurality of control messages from the distal control unit, a signal receiving unit receiving an input operating signal from a proximal control unit for controlling a common home appliance, a signal transmitting unit transmitting an output operating signal controlling a common home appliance, and a managing module receiving data from the signal receiving unit and the network communication unit and choosing the output operating signal transmitted by the signal transmitting unit.

Optionally, the proximal control unit is a remote control.

Optionally, the input operating signals are infra red signals.

Optionally, a network communication method of the network communication unit is at least one of a wireless local area network and a cellular network.

Optionally, the output operating signal and the input operating signal are the same signal type.

Optionally, the choosing the output operating signal by the managing module is performed by applying logical rules to the at least one of a plurality of control messages and to the input operating signal.

Optionally, the device comprises at least one sensor unit which detects a characteristic and the data of the characteristic is transferred to the managing module.

More optionally, the characteristics are at least one of temperature, moisture, presence of an identification tag, distance of an identification tag.

Optionally, the distal control unit comprises an application of a user end device.

More optionally, the application of a user end device is a smart mobile phone application.

More optionally, the network communication unit comprises a router and a communication between the application of a user end device and the client management module is performed by the router.

More optionally, the distant control unit comprises a client management module communicating with the application of a user end device.

More optionally, the client management module communicates with the application of a user end device using an internet protocol.

Optionally, the device comprises at least one sensor unit which detects a characteristic and the data of the characteristic is transferred to the client management module.

Optionally, the device comprises a database wherein the client management module stores data in the database and the client management module reads data from the database.

Optionally, the device comprises a central unit which manages the client management module.

Optionally, the appliance is one of an air conditioner, a heating device, an electric shading device and a television.

Optionally, the device comprises the common home appliance.

According to some embodiments of the present invention, there is provided a method for providing unified control over common home appliances. The method comprises receiving an input operating signal for controlling a common home appliance from a proximal control unit by a signal receiving unit, receiving at least one of a plurality of control messages from a distal control unit, generating an output operating signal according to the input operating signal and the at least one of a plurality of control messages, and transmitting the output operating signal by a signal transmitting unit.

Optionally, the output operating signal is transmitted in same manner as the input operating signal.

Optionally, the method comprises deducing a state of the common home appliance according to received the input operating signal and received the at least one of a plurality of control messages.

Optionally, the method comprises sending at least one of a plurality of control messages from a distal control unit.

Optionally, the method comprises sending of a plurality of control messages from an application of a user end device to a client management module via a router.

Optionally, the method comprises receiving data from a sensor unit by at least one of a client management module and a managing module.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is an illustration of components of a device for controlling infra red operated common home appliances, according to some embodiments of the present invention;

FIG. 2 is an illustration of an exemplary structure of a client management module, according to some embodiments of the present invention;

FIG. 3 is an illustration of an internal structure of an Infra Red (IR) module, according to some embodiments of the present invention;

FIG. 4 is an illustration of an internal structure of a sensor module, according to some embodiments of the present invention;

FIG. 5 is an illustration of a flow of a command from an application of a user end device to an appliance, according to some embodiments of the present invention;

FIG. 6 is an illustration of a flow of operation data from an IR module to an application of a user end device, according to some embodiments of the present invention;

FIG. 7 is an illustration of data and commands flow of a client management module's operational mode, according to some embodiments of the present invention;

FIG. 8 is an illustration of data and commands flow of a server's operational mode, according to some embodiments of the present invention;

FIG. 9 is an illustration of data and commands flow of an IR module's operational mode, according to some embodiments of the present invention; and

FIG. 10 is an illustration of a method for controlling IR operated common home appliances for controlling an appliance, according to some embodiments of the present invention.

### DESCRIPTION OF EMBODIMENTS OF THE INVENTION

The present invention, in some embodiments thereof, relates to a remote monitoring of appliances and, more particularly, but not exclusively, to devices and methods for controlling appliances by receiving input operating signal(s) from a proximal control unit and receiving control message(s) from distal control unit, as well as transmitting output operating signal(s) to an appliance.

According to some embodiments of the present invention, there are provided devices and methods for providing a unified control over common home appliances, such as air conditioners, heating devices, and sound devices, TV, and/or a home appliance activated by a remote control, for example IR signal by managing local and remote control signals according to a dynamic and/or static control pattern and/or set of rules. The device includes a signal receiving unit that is placed in proximity to a receiver of a home appliance and set to receive both local operating signals which are transmitted to the home appliance by a user control device and remote control signals which are triggered from a distal control unit. For example, the signal receiving unit detects proximal operating signals directed at a common home appliance, such as IR waves sent from a remote control. A distal control unit, which is controlled regardless of its physical proximity to the appliance, may send control messages to the receiving unit. The distant control unit may be a client terminal hosting a user application, for example a Smartphone hosting an application downloaded from an app store. The distal control unit may be positioned in physical proximity to the controlled home appliance 110.

A sensor unit is a detector of physical properties, chemical properties and/or a combination thereof. One or more sensor units may collect data about the outcome of an appliance's operation, such as temperature, moisture, light and/or the like. Optionally, the sensor unit includes a sensor which monitors the operation of the appliance itself. For example an image sensor which images a keypad and/or a set of operation buttons of the appliance and/or any other sensor which monitors a pre-existing man machine interface (MMI) of the appliance. The client management module and/or the server may generate commands in the form of control messages and/or output operating signals to adjust the appliance operation according to preset requirements regarding measured parameters and/or other data which is accessible by the system at the time, for instance weather data accessible from a network address, such as a website, current information from an electricity provider, data from a smart meter regarding the local grid consumption and/or the like.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

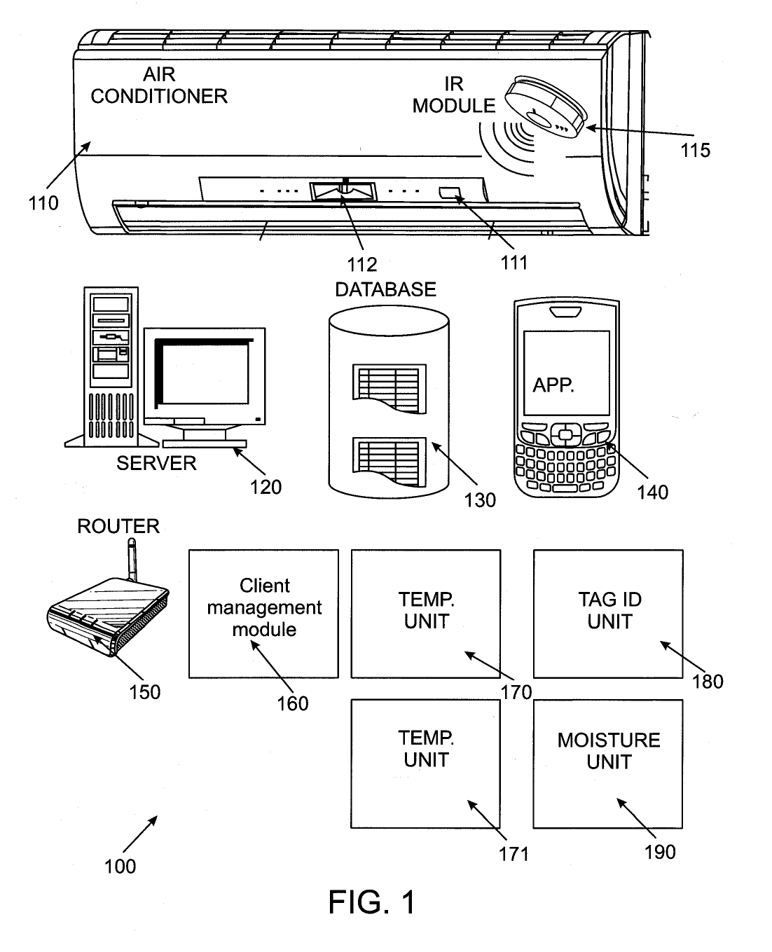

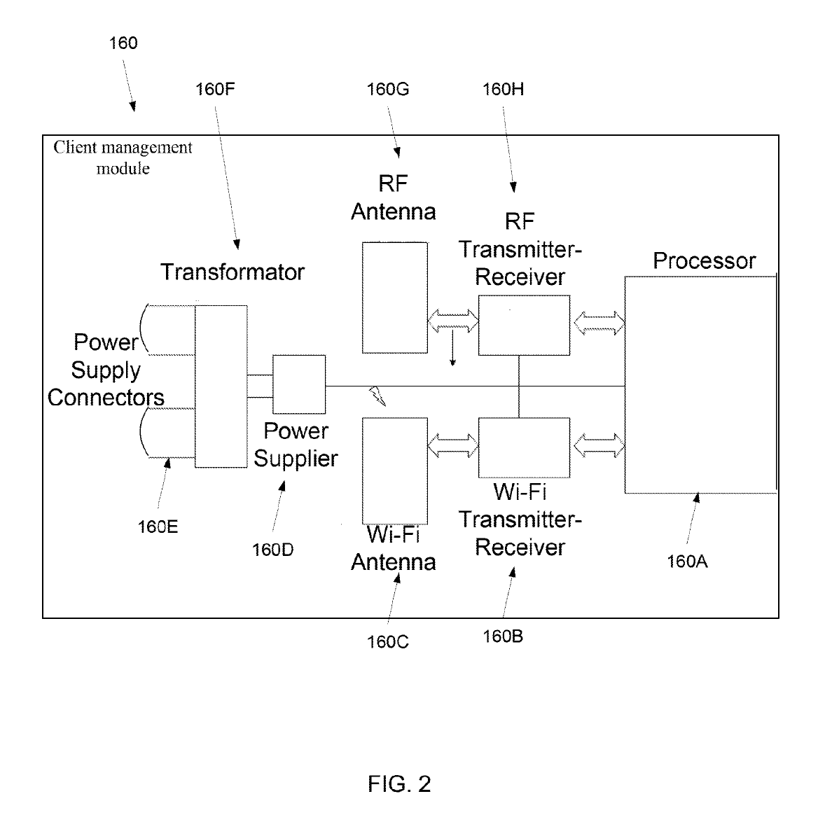

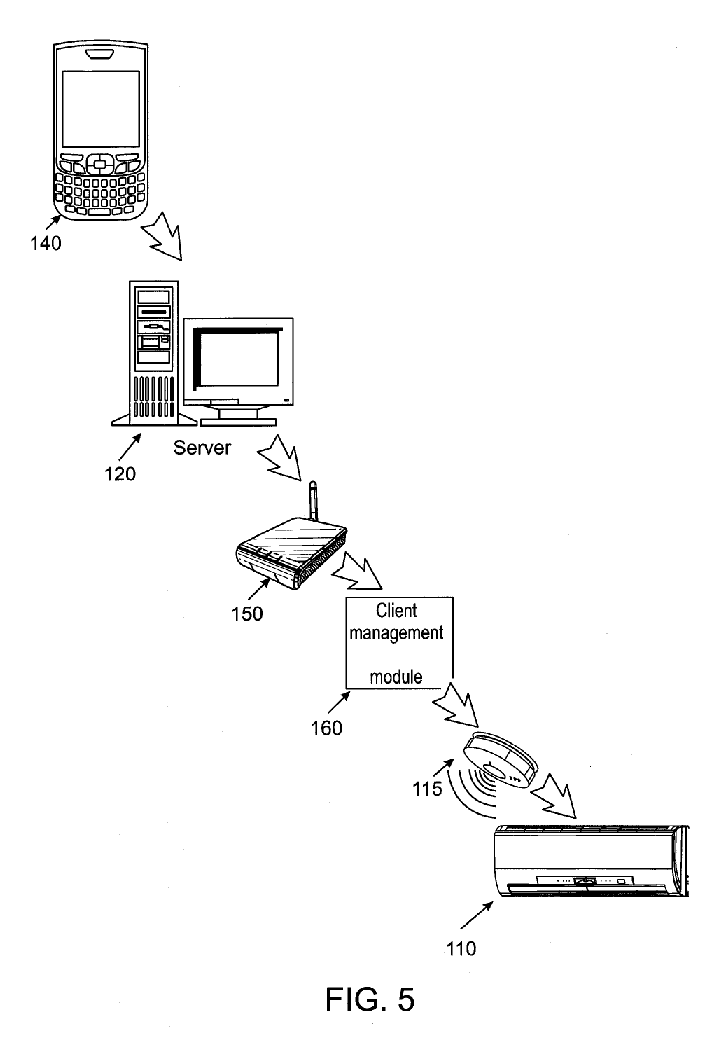

Referring now to the drawings, FIG. 1 illustrates components of a device for controlling IR operated common home appliances 100, according to some embodiments of the present invention. In this example, the appliance is an air conditioner 110. The device 100 includes an IR module 115, a server 120, an application of a user end device 140, a router 150 and a client management module 160. In this example the user end device 140 is a mobile phone. Optionally, the device 100 further includes a database 130, one or more temperature unit(s) 170, a tag identification unit 180 and/or a moisture unit 190. Exemplary structures of the client management module 160, the IR module 115 and the temperature module 170 are illustrated and described in FIGS. 2, 3 and 4 respectively. Exemplary interactions between the components of this device 100 are illustrated in FIGS. 5-10. The IR module 115 may be located on top of the appliance 110. Optionally, the IR module 115 may be located in different positions with respect to the appliance 110. For example, the IR module 115 may be mounted on a wall under the appliance 110. The location of the IR module 115 allows it to detect IR signals directed at the appliance 110. The location of the IR module 115 allows it to transmit IR signals to the appliance 110. The server 120 may be linked to one or more databases 130. The database 130 may include users of a service, sets of IR commands for different appliances 110, details of appliance service providers and/or related advertisement content. Optionally, the IR module 115 and/or the client management module 160 and/or sensor module comprises a memory unit 115E storing sets of IR commands for different appliances. The memory unit 115E can be inside the processor and/or as an external component. The IR commands may be updated in advance and/or from time to time according to various standards and protocols.

Reference is now made to FIG. 2, which illustrates an exemplary structure of a client management module 160, according to some embodiments of the present invention. The client management module 160 communicates with the different modules and/or units. The client management module 160 communicates with the router 150 over a network such as the internet. The client management module 160 may include a network interface for establishing a direct connection to the internet, without an external router. The client management module 160 gets power supply, for example by a power supplier 160D and power supply connectors 160E which are connected to an external power source such as the electricity system, a USB device etc. It should be noted that the power source may be a battery, external or internal, optionally rechargeable. The RF transmitter/receiver 160H transmits and receives data through an RF antenna 160G. The RF transmitter/receiver 160H communicates with the IR module 115. The Wi-Fi transmitter/receiver 160B transmits and receives data through a Wi-Fi antenna 160C. Additionally or alternatively, a LAN transmitter/receiver 160B may be used for wired connection. The Wi-Fi transmitter/receiver 160B communicates with the router 150. The processor 160A transmits and receives data from the RF transmitter/receiver 160H and/or the Wi-Fi transmitter/receiver 160B. The managing module, shown here as a IR module processor 160A, may process data to generate the appropriate commands for the RF transmitter/receiver 160H and Wi-Fi transmitter/receiver 160B. The client management module 160 has a configuration mode. The configuration mode may be triggered by a physical button on the client management module 160 and/or via application only. The configuration mode may be performed through the application of a user end device an application of a user end device 140, such as a smart phone. For example, the application of a user end device 140 enables a user to define a home network as the chosen Wi-Fi network for the Wi-Fi transmitter/receiver 160B and Wi-Fi antenna 160C. It allows the client management module 160 to use the chosen network as the client management module's 160 Wi-Fi connection. The configuration mode may further allow a user to register to a service, choose a user name and/or setup a user password. The registration may be performed in a website provided by the server 120. The client management module 160 also has an operation mode. In its operation mode the client management module 160 communicates with the server 120, the IR module IR module 115 and optionally with sensor module(s) 170 such as temperature unit(s) 171, tag identification unit 172(s) and/or moisture unit(s) 173. The communication between the client management module 160 and the server 120 may be performed using a router 150 and/or directly, for example as exemplified above. The client management module 160 checks if the server 120 issued a new command and/or updates the server 120 with current data such as receiving a command from an IR remote control by the IR module 115, measured temperature, measured moisture, current air conditioner status (on, off, cooling level). The data transferred by the client management module 160 may also be inferred data such as estimated energy consumption, time since last turned on, overall daily operation time etc. The client management module 160 may send commands to the IR module 115 and/or get notification about a command sent to the IR module 115 via an IR remote control. The temperature unit 171 and/or moisture unit 172 may report temperature and moisture measurements to the client management module 160, respectively.

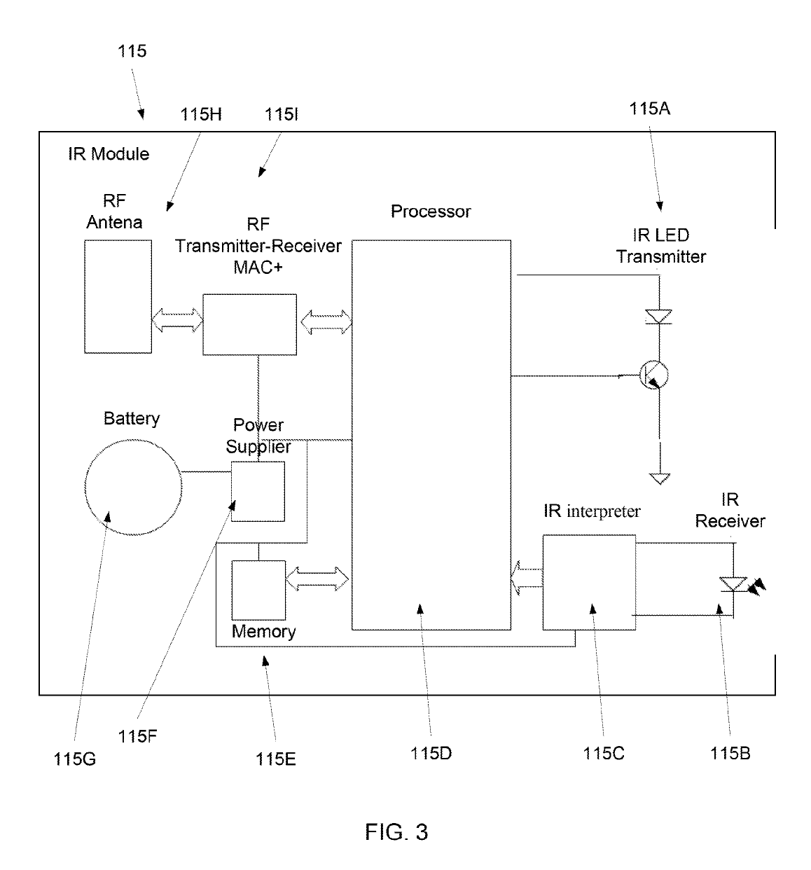

Reference is now made to FIG. 3, which illustrates an internal structure of an IR module 115, according to some embodiments of the present invention. The IR module 115 is a detector for detecting IR commands sent to the appliance 110. The IR module 115 is also an intermediary which translates the client management module 160 control messages into appliance 110 operating signals. The IR module 115 sends output operating signals to the appliance 110 and detects IR input operating signals provided to the appliance 110. The appliance 110 is controlled by IR. The commands may be provided to the appliance 110 by a remote control and/or other IR means. The IR module processor 115D creates an IR signal to control the appliance 110. The IR module 115 is composed of and/or connected to an IR light emitting diode (LED) transmitter 115A, IR receiver 115B, an IR interpreter 115C, an IR module processor 115D, a power supplier 115F, a power source 115G, such as a battery or mains, an radio frequency (RF) antenna 115H and an RF transmitter-receiver 1151. Optionally, the IR module 115 further includes a memory unit 115E which may be a part of the IR module processor 115D.

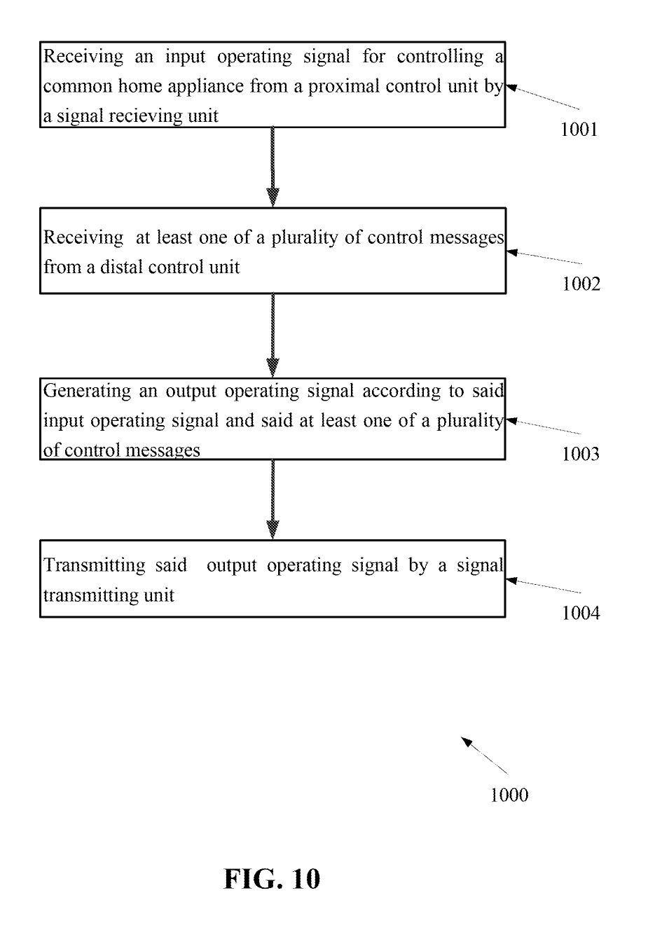

The power source 115G provides electricity to the power supplier 115F. The power supplier 115F provides power, directly and/or indirectly, to the rest of the IR module 115 elements listed above 115A-115I. The IR module processor 115D is connected to the RF transmitter-receiver 115I, the memory unit 115E (if exists), the IR receiver 115C and the LED transmitter 115A. The RF transmitter-receiver 115I communicates with the client management module 160 through the RF antenna 115H. The RF transmitter-receiver 115I receives IR signals, decipher them and send them to the IR module processor 115D. The IR module processor 115D generates appliance commands and transfers them to the LED transmitter 115A. The LED transmitter 115A sends IR operating signals to the appliance 110. The IR signals may turn the appliance 110 on, turn the appliance 110 off, set the temperature and/or move a shutter etc. The IR LED receiver 115B receives IR signals sent to the appliance 110 by a remote control and/or other IR transmission means. The IR LED receiver 115B transmits the IR signals to the IR receiver 115C which deciphers them and transfers them to the IR module processor 115D. Optionally, the IR receiver 115B is a part of IR receiver 115C. The IR module processor receives data about IR signals from the RF receiver 115C, data about RF signals from the RF transmitter-receiver 115I. An exemplary operation of the IR module 115 is illustrated in FIG. 10. Optionally, the IR module processor 115D receives stored data from the memory unit 115E. The IR module processor 115D combines these data and generates commands for the appliance 110 which are transmitted through the LED transmitter 115A and/or updates the application of a user end device 140 through the RF transmitter-receiver 115I. Optionally, the IR module processor stores data in the memory unit 115E. Optionally, the IR module 115 has an IR module configuration mode. In its configuration mode the IR module 115 may be related to the client management module 160. Optionally, the RF transmitter-receiver 115I has a Media Access Control (MAC) address. The MAC address is transmitted by the IR module 115 to the client management module 160 for associating the two devices 115, 160 and/or exchanged therebetween. The client management module 160 only responds to related IR modules 115. Relating an IR module 115 and a client management module 160 enables multiple proximal client management modules 160 and IR modules 115 to work side by side without clashing and having their transmissions interfere with each other's operation. Optionally, the user defines the relationship between control messages and IR operating signals in the IR module configuration mode. For example, the user aims a remote control at an air conditioner appliance 110 and presses a button to generate an IR operating signal to the air conditioner. The IR module 115 receives and deciphers the IR signal and stores it locally in the memory unit 115E and/or externally at the client management module 160 and/or at the server along with the interpretation of the control message. Optionally, the client management module 160 is connected to a database server 120 which stores sets of IR operating signals by appliance type, make and/or model. In the IR module configuration the user may choose the appropriate set of operating signals from predefined sets of operating signals. Optionally this database lies in the IR module itself and/or the client management unit. Optionally, the IR module 115 has communication capabilities for exchanging data with a distal control unit and/or a sensor unit(s). Optionally, the IR module 115 communication capabilities replace the client management module 160 and/or database capabilities from the server. Optionally, the device for unified control has a client management module 160 alongside an IR module 115 with communication capabilities. Optionally, a secondary communication network is formed between the IR module 115 having communication capabilities and the client management module 160. For example, the IR module 115 has a sensor which detects physical and/or characteristics changes and/or integrated Wi-Fi components, for example a transceiver and/or a respective antenna.

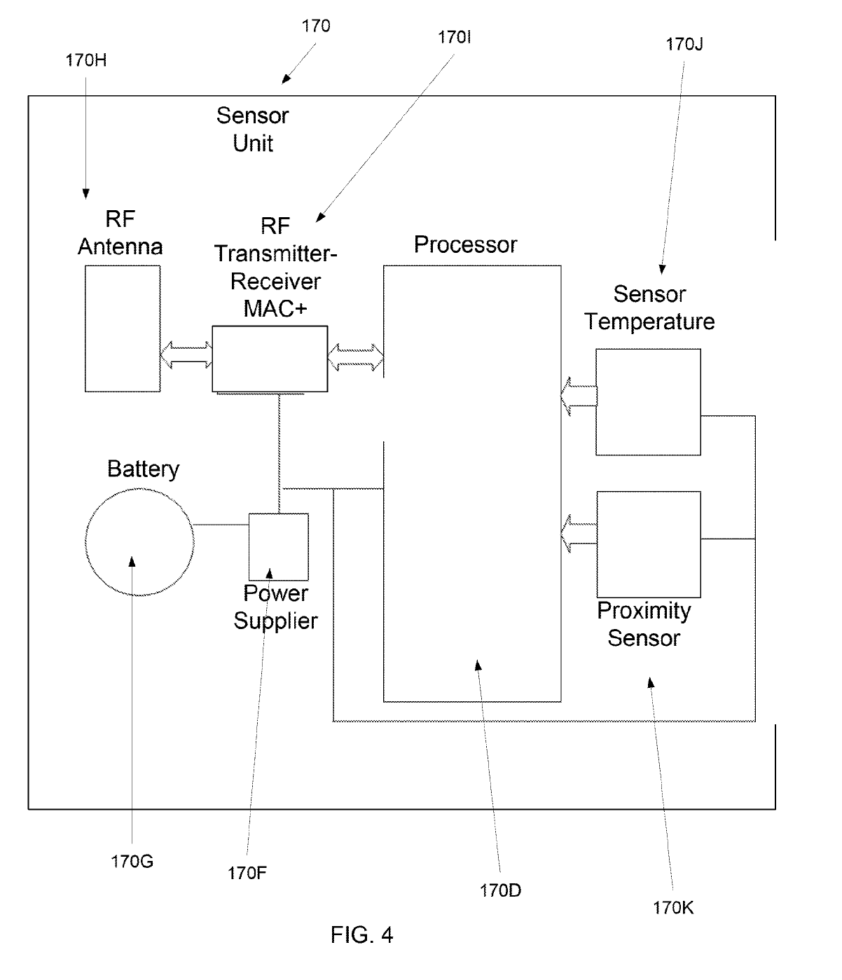

Reference is now made to FIG. 4, which illustrates an internal structure of a sensor module 170, according to some embodiments of the present invention. A device for controlling IR operated appliances 100 optionally includes a sensor unit 170. The sensor unit 170 has one or more sensors 170J, 170K which detect temperature, moisture, proximity and/or appliance 110 relevant measurements. The sensor(s) 170J, 170K transfer their measurements to a sensor unit processor 170D. The sensor unit processor 170D transfers relevant measurement(s) to the RF transmitter-receiver 170I which transmits it to the client management module 160 through an RF antenna 170H. The sensor unit 170 provides the client management module 160 with measurement data. The client management module 160 uses this data to control the appliance 110 to adjust its performance to predefined settings and/or users commands such as desired measured temperature, desired moisture level, user location with respect to sensor, external local weather data, maximum energy consumption per day and/or combination thereof. Optionally, the client management module 160 sends the data to the server 120 and/or user application 140.

Optionally, the location of the sensors 170J, 170K in a room is defined in the sensor unit 170 and/or the client management module 160. The sensors' 170J, 170K location may be used to adjust for non uniform temperature distribution in an air conditioned space. For example, two temperature sensors 170J are installed on two different walls of the same air conditioned room. The first temperature sensor 170J, located to the left of the air conditioner, measures a higher temperature than the second temperature sensor 170J, located to the right of the air conditioner. The RF antenna 170H transmits the temperature data to the client management module 160 and the client management module 160 generates an IR operating signals to the air conditioner 110 to move the shutters towards the left to lower the temperature on that side of the room. A proximity sensor may be used to identify the location of one or more persons in proximity to the air conditioner 110 and/or the distance thereof. This allows controlling the angle of the fans of the air conditioner 110, in real time, based on the location of the person. The data of the proximity sensor 170K, may be used to decide turn on an appliance 110 and/or to control the appliance 110 in a way that creates comfortable conditions in the proximity of the person(s).

Reference is now made to FIG. 5, which illustrates a flow of a command from an application of a user end device 140 to an appliance 110, according to some embodiments of the present invention. A user issues a command as a control message sent through an application of a user end device 140. The control message is transferred from the Internet Protocol (IP) of the application of a user end device 140, optionally through a router 15to the client management module 160 and/or directly to the client management module 160. In this example the application of a user end device 140 is an application of a smart phone. The client management module 160 sends the command of the control message as an RF signal and/or an IR signal to the IR module 115. The IR module 115 sends the command to the appliance 110, in this example an air conditioner. Optionally, the command may be modified when transferred between different components. Optionally, the command may flow through different components from different user end devices. Optionally, upon receipt of a command a confirmation is sent to a user end device 140. Optionally, upon failure to send a command through one flow between components an alternative flow is initiated to transfer the same command.

Optionally, the flow of operation data is performed continuously and/or at frequent discrete intervals. Optionally, the flow of operation data is performed for multiple operation data parameters. Optionally, the flow of operation data is performed in real time.

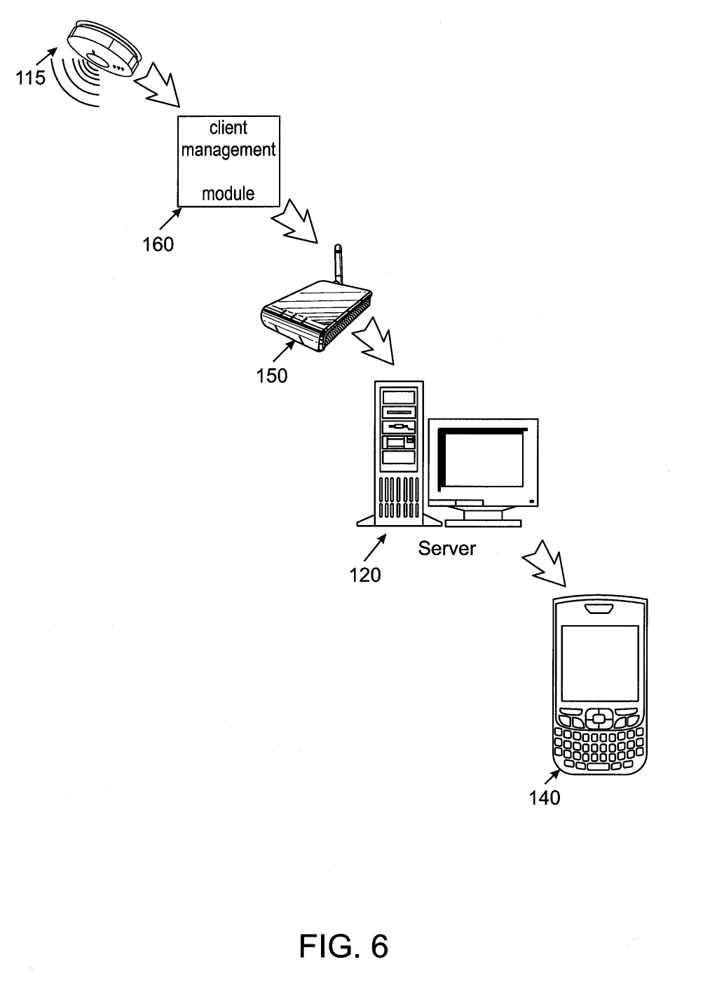

Reference is now made to FIG. 6, which illustrates a flow of operation data from an IR module 115 to an application of a user end device 140, according to some embodiments of the present invention. An IR module 115 sends a status containing operation data to a client management module 160. Operation data may be a current target temperature, time since a user end device was turned on, measured temperature in a room, proximity of a tag identifier to an IR module 115, issued command from a remote control, measurement from optional sensor included in the IR module and/or the like. The client management module 160 sends the operation data to a server 120 through a router 150. The server 120 connects with the application of a user end device 140 to present the operation data as part of the application 140. Optionally, the flow of operation data is performed upon a trigger from a user through the application of a user end device 140. Optionally, the flow of operation data is performed continuously and/or at frequent discrete intervals. Optionally, the flow of operation data is performed for multiple operation data parameters. Optionally, the flow of operation data is performed in real time.

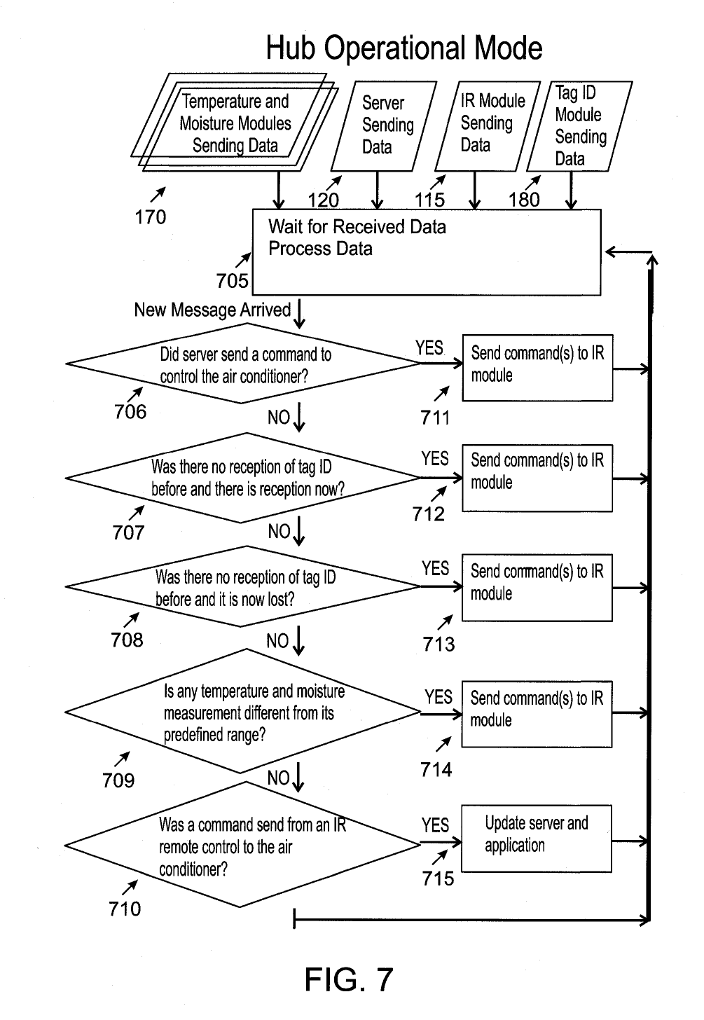

Reference is now made to FIG. 7, which illustrates data and commands flow of a client management module 160′s operational mode, according to some embodiments of the present invention. The client management module 160 waits for data 705 from one or more sensor unit 170, server 120, IR module 115 and/or tag identification module 180, one or more sensor unit 170, and or server 120, and or IR module 115 and/or tag identification module 180. The client management module 160 may listen constantly to the different elements 170, 115, 180, 160. Optionally, the client management module 160 checks upon the different elements 170, 115, 180, 160 in predefined intervals. Upon the receipt of a new message 705, the client management module 160 checks 706 whether the server 120 issued a command to control an appliance 110 such as an air conditioner. If so, the client management module 160 sends command(s) 711 to the IR module 115. Otherwise, the client management module 160 checks if an identification tag is back in reception 707. If so client management module 160 sends command(s) 712 to the IR module 115. For example, to turn on an appliance 110 upon gain of identification tag reception. Otherwise, if a reception of an identification tag was lost 708 the client management module 160 sends a command 713 to the IR module 115. For example, to turn off an appliance 110 upon loss of identification tag reception. Otherwise, if the measured parameters are different, a predefined value and/or range 709 the client management module 160 sends operating signal(s) as RF signal(s) and/or IR signal(s) 714 to the IR module 115. For example, the measured temperature by a temperature unit 171 is 25 Celsius degrees and the predefined temperature range as set by a user using the application of a user end device 140 is 22-23 Celsius degrees. The client management module 160 issues an IR command to lower the temperature by 2 Celsius degrees and send it through the IR module 115 to the air conditioner 110. Optionally, the client management module 160 transfers that information to a server 120 which issues an IR command accordingly. If the measured parameters are as defined, the client management module 160 checks for an IR command issued by an IR controller of the appliance 110, for example a remote control of an air conditioner 710. If such a command was sent, the client management module 160 updates the server 120, for example, through IP based communication. After commands 711-715 are issued to the IR module 115 the client management module 160 returns to the listening mode 705. Optionally, the sequence of the operations 705-715 may vary. For example, checking for a command from an IR remote control second trial 710 may precede the check for a server command 706.

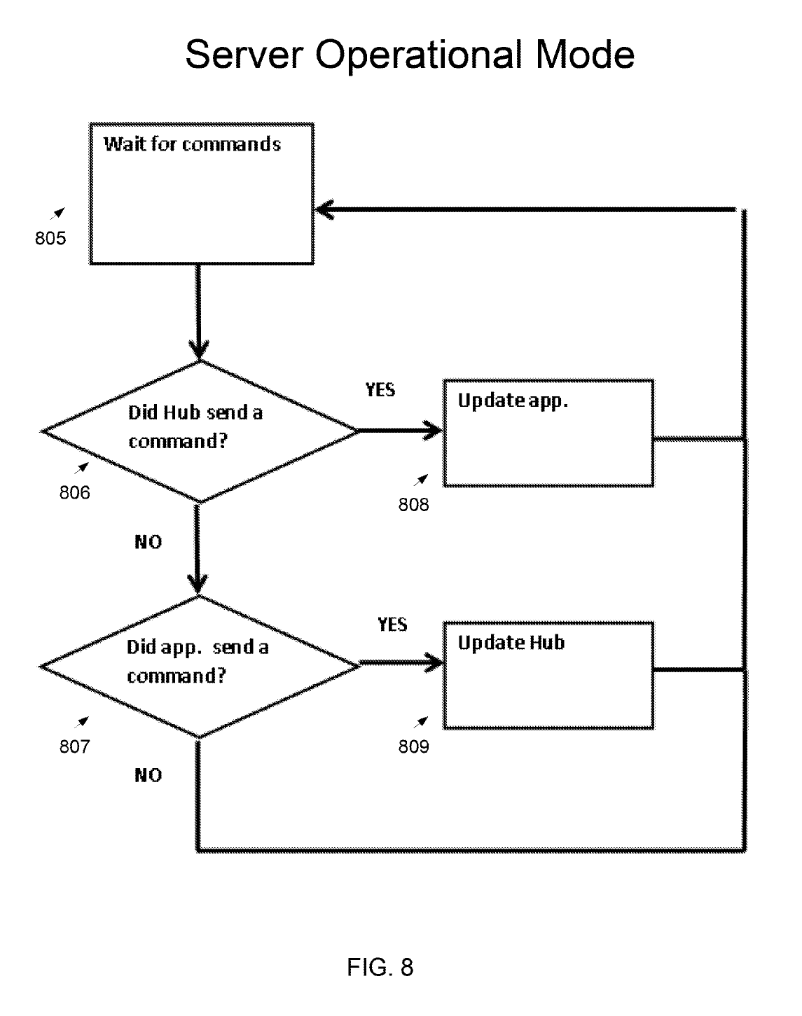

Reference is now made to FIG. 8, which illustrates data and commands flow of a server 120's 130 operational mode, according to some embodiments of the present invention. The server 120 receives data and/or commands 807 from an application of a user end device 140, processes it and sends data and/or control messages 809 to the client management module 160. The server 120 receives data and/or control messages 806 from the client management module 160, processes it and sends data and/or commands 808 to the application of a user end device 140.

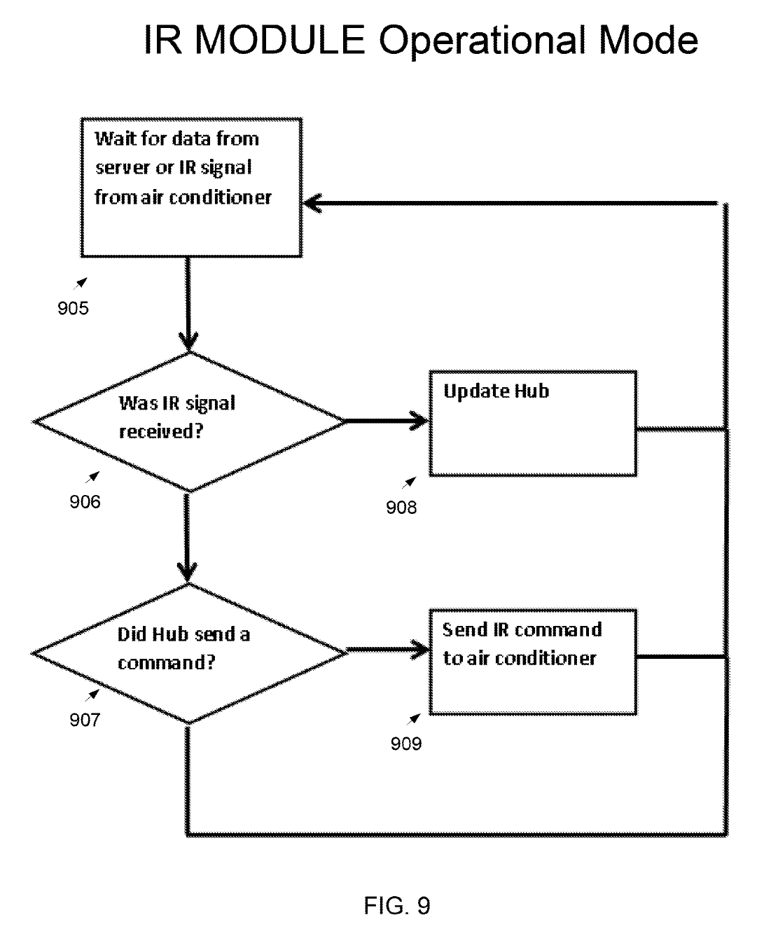

Reference is now made to FIG. 9, which illustrates data and commands flow of an IR module's 115 operational mode, according to some embodiments of the present invention. The IR module 115 listens 906 to IR operating signals issued to the appliance 110. Upon receiving an IR operating signal the IR module 115 updates 908 the client management module 160. The IR module 115 listens to issued client management module 160 signals 907. Upon receiving a client management module 160′s 160 command the IR module 115 sends 909 an IR operating signal to the appliance 110.

Reference is now made to FIG. 10, which illustrates a method 1000 for controlling IR operated appliances 100 for controlling a common home appliance, according to some embodiments of the present invention. First, input operating signal for controlling a common home appliance from a proximal control unit are received by a signal receiving unit 1001. Optionally, the proximal control unit is a remote control. Optionally, the proximal control unit communicates with another element of the device 100 for controlling IR operated appliances 100 by IR operating signals. The input operating signals are received by a proximal signal unit. Next, one or more control messages are received from a distal control unit 1002. The order of receiving operating signals and control messages may vary. The control messages and operating signals may be received alternately and/or simultaneously. Next, an output operating signal is generated according to the input operating signal and/or the control message(s) 1003.

Optionally, the client management module 160 access a set of rules to determine which operating signal to select in response to a received control messages and/or operating signal. Each rule defines an operation signal generation instructions and a pattern indicative of a current operation of the IR operated appliance 100, a status and/or information about a lately received control message and/or operating signals. In such a manner, when a match is found between the pattern of the rule and a current image of operating the IR operated appliance 100, the respective operating signal is selected to be transmitted. In such a manner, the rule may define which operation signal overcomes another. For example, if a control message for deactivating an air-conditioner is identified during a certain period (e.g. 1 minute, 5 minute, 15 minute and/or any intermediate or longer period) after an operation signal to activate an air-conditioner is received, the control message is ignored. In another example, operation signals are ignored if a control message for deactivating an air-conditioner is identified from a certain user having certain credentials. In another example, an operation signal is determined based on a combination of a control message/local operation signal and current status that is identified by local sensors, for example a current temperature, current moisture and/or the like.

In another example, an operation signal is determined based on a combination of a control message and a local operation signal which are received in certain time proximity, for example within a period of several minutes. The combination may yield selecting an operation signal indicative of an average and/or mean target value, for example when the control message and the local operation signal define different target values. The combination may yield selecting an operation signal indicative of a sequence of different instructions. Finally, the selected output operating signal is transmitted by a signal transmitting unit 1004. Optionally, the output operating signal is transmitted in same manner as the input operating signal. For example, both the input operating signal and output input operating signal are transmitter by an IR channel. Optionally, the state of an appliance 110 is deduced according to received control messages and operating signals. For example, an air conditioner appliance 110 has a single button for turning on and off. The air conditioner is turned on via a remote control. Optionally, an application of a user end device 140 sends a command, as a control message, to a client management module 160 via a router 150. A signal module, such as an IR module 115, receives a “turn on” IR signal which was sent from a remote control. The IR module 115 sends the turn on status to a client management module 160. An application of a user end device 140, such as a smart mobile phone application, sends a command to turn on the air conditioner 110 to the client management module 160. The client management module 160 which knows the current status of the air conditioner 110 does not send another IR signal to the turn on/turn off button. Optionally, the signal transmitting unit transmits output operating signals to control the appliance. Optionally, a client management module 160 receives data from a sensor unit 170. The client management module 160 may send commands according to the received sensor data. Optionally, the client management module 160 transfers the received sensor data to a server 120 and gets from the server 120 commands according to sensor data.

It is expected that during the life of a patent maturing from this application many relevant IR control devices and methods, appliances, appliance control technologies, applications of a user end device, sensors, client management modules, routers, servers, databases, and/or tag identification devices and methods will be developed and the scope of the terms application, IR control device and/or method, appliance, appliance control technology, application of a user end device, sensor, client management module, router, servers, database, and/or tag identification device and/or method are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

What is claimed is:

1. A device for providing a unified control over common home appliances, comprising:
a distal control unit;
a network communication unit receiving at least one of a plurality of control messages from said distal control unit;
a signal receiving unit receiving an input operating signal from a proximal control unit for controlling a common home appliance;
a signal transmitting unit transmitting an output operating signal controlling a common home appliance; and
a managing module receiving data from said signal receiving unit and said network communication unit and choosing said output operating signal transmitted by said signal transmitting unit.

2. The device of claim 1, wherein said proximal control unit is a remote control.

3. The device of claim 1, wherein said input operating signals are infra red signals.

4. The device of claim 1, wherein a network communication method of said network communication unit is at least one of a wireless local area network and a cellular network.

5. The device of claim 1, wherein said output operating signal and said input operating signal are the same signal type.

6. The device of claim 1, wherein said choosing said output operating signal by said managing module is performed by applying logical rules to said at least one of a plurality of control messages and to said input operating signal.

7. The device of claim 1, further comprising at least one sensor unit which detects a characteristic and said data of said characteristic is transferred to said managing module.

8. The device of claim 7, wherein said characteristics are at least one of temperature, moisture, presence of an identification tag, distance of an identification tag.

9. The device of claim 1, wherein said distal control unit comprises an application of a user end device.

10. The device of claim 9, wherein said application of a user end device is a smart mobile phone application.

11. The device of claim 9, wherein said network communication unit comprises a router and a communication between said application of a user end device and said client management module is performed by said router.

12. The device of claim 9, wherein said distant control unit comprises a client management module communicating with said application of a user end device.

13. The device of claim 12, wherein said client management module communicates with said application of a user end device using an internet protocol.

14. The device of claim 12, further comprising at least one sensor unit which detects a characteristic and said data of said characteristic is transferred to said client management module.

15. The device of claim 12, further comprising a database wherein said client management module stores data in said database and said client management module reads data from said database.

16. The device of claim 12, further comprising a central unit which manages said client management module.

17. The device of claim 1, wherein said appliance is one of an air conditioner, a heating device, an electric shading device and a television.

18. The device of claim 1, further comprising said common home appliance.

19. A method for providing unified control over common home appliances, comprising:
receiving an input operating signal for controlling a common home appliance from a proximal control unit by a signal receiving unit;
receiving at least one of a plurality of control messages from a distal control unit;
generating an output operating signal according to said input operating signal and said at least one of a plurality of control messages; and
transmitting said output operating signal by a signal transmitting unit.

20. The method of claim 19, wherein said output operating signal is transmitted in same manner as said input operating signal.

21. The method of claim 19, further comprising deducing a state of said common home appliance according to received said input operating signal and received said at least one of a plurality of control messages.

22. The method of claim 19, further comprising sending at least one of a plurality of control messages from a distal control unit.

23. The method of claim 19, further comprising sending of a plurality of control messages from an application of a user end device to a client management module via a router.

24. The method of claim 19, further comprising receiving data from a sensor unit by at least one of a client management module and a managing module.
